(19) United States
(12) Patent Application Publication
(10) Pub. No.: US 2026/0301281 A1
(43) Pub. Date: Oct. 1, 2026

(54) CONDITIONAL THREE-DIMENSIONAL (3D) DENOISING OF POSITRON EMISSION TOMOGRAPHY (PET) IMAGES

(71) Applicant: University of Florida Research Foundation, Incorporated, Gainesville, FL (US)

(72) Inventors: Kuang Gong, Gainesville, FL (US); Boxiao Yu, Gainesville, FL (US)

(21) Appl. No.: 19/577,674

(22) Filed: Mar. 25, 2026

Related U.S. Application Data
(60) Provisional application No. 63/781,674, filed on Apr. 1, 2025.

(51) Int. Cl. G06T 12/30; G06T 5/70

(52) U.S. Cl. CPC G06T 12/30; G06T 5/70; G06T 2207/10104; G06T 2211/441

(57) ABSTRACT

A method comprising receiving a low-dose positron emission tomography (PET) image; providing the low-dose PET image as a conditional input to a neural network model of a plurality of neural network models trained using a three-dimensional denoising diffusion probabilistic model (3D DDPM), wherein the neural network model comprises a score function that corresponds to a training of the neural network model based on three-dimensional distribution information of a plurality of normal-dose PET images that comprises a desired image quality; and providing the low-dose PET image to the neural network model to produce a denoised PET image, wherein the denoised PET image is iteratively reconstructed from the low-dose PET image during a reverse diffusion process in accordance with the score function.

### CROSS REFERENCE TO RELATED APPLICATION

This application claims the priority of U.S. Provisional Application No. 63/781,674, entitled “CONDITIONAL THREE-DIMENSIONAL (3D) DENOISING OF POSITRON EMISSION TOMOGRAPHY (PET) IMAGES,” filed on Apr. 1, 2025, the disclosure of which is hereby incorporated by reference in its entirety.

### GOVERNMENT SUPPORT

This invention was made with government support under Grant No(s). R01 EB034692 and R01 AG078250, awarded by the National Institutes of Health. The government has certain rights in the invention.

### BACKGROUND

Positron emission tomography (PET) provides an imaging modality that may be used in clinical diagnosis and preclinical research of diseases, such as cancer, neurodegenerative diseases, and cardiac diseases, due to its high sensitivity and precise quantification capabilities. Due to concerns regarding radiation exposure and/or potential cancer risk, PET injection dose or scanning time may be reduced. However, such reductions may lead to a deterioration of PET image quality with respect to quantitative accuracy and lesion detectability. That is, due to various physical degradation factors and limited photon counts detected, restrictions in image resolution and signal-to-noise ratio inhibit the generation of high-quality images from low-dose PET scans. Accordingly, enhancing PET image quality to maintain quantitative accuracy and lesion detectability at both normal-dose and low-dose scenarios is desirable.

### BRIEF SUMMARY

Various embodiments described herein relate to methods, apparatus, systems, computing devices, computing entities, and/or the like for denoising images.

According to some embodiments, a method comprises receiving, by one or more processors, a low-dose positron emission tomography (PET) image; providing, by the one or more processors, the low-dose PET image as a conditional input to a neural network model of a plurality of neural network models trained using a three-dimensional denoising diffusion probabilistic model (3D DDPM), wherein the neural network model comprises a score function that corresponds to a training of the neural network model based on three-dimensional distribution information of a plurality of normal-dose PET images that comprises a desired image quality; and providing, by the one or more processors, the low-dose PET image to the neural network model to produce a denoised PET image, wherein the denoised PET image is iteratively reconstructed from the low-dose PET image during a reverse diffusion process in accordance with the score function.

In some embodiments, the method further comprises generating, using a perception agent, a perception output based on the low-dose PET image, wherein the perception output comprises a misalignment, a noise level, or a lesion characterization; determining, using a scheduling agent and based on the perception output, one or more denoising parameters in association with the neural network model; generating, using the neural network model, a reconstructed image by performing a denoising operation on the low-dose PET image in accordance with the one or more denoising parameters; and providing, using a feedback agent, the reconstructed image as the denoised PET image based on the reconstructed image meeting or exceeding a quality criterion.

In some embodiments, the method further comprises in response to the feedback agent determining that the denoised PET image does not satisfy the quality criterion, determining, using the scheduling agent, one or more alternative denoising parameters in association with another neural network model of the plurality of neural network models. In some embodiments, the feedback agent is configured to cause iterative refinement of the denoising operation such that the denoised PET image satisfies the quality criterion. In some embodiments, the plurality of neural network models is configured for a plurality of dose levels. In some embodiments, the method further comprises training the 3D DDPM by incrementally adding noise to the plurality of normal-dose PET images during a forward diffusion process; and generating, based on the low-dose PET image, the denoised PET image from Gaussian noise during the reverse diffusion process. In some embodiments, the method further comprises cropping the low-dose PET image; and dividing the low-dose PET image along an axial direction into a plurality of patches, wherein the plurality of patches overlaps sequentially by a plurality of pixels with a weighted arithmetic mean between adjacent patches of the plurality of patches.

According to some embodiments, a system comprises one or more processors and one or more non-transitory computer readable media storing processor-executable instructions that, when executed by the one or more processors, cause the one or more processors to perform operations comprising receiving a low-dose positron emission tomography (PET) image; providing the low-dose PET image as a conditional input to a neural network model of a plurality of neural network models trained using a three-dimensional denoising diffusion probabilistic model (3D DDPM), wherein the neural network model comprises a score function that corresponds to a training of the neural network model based on three-dimensional distribution information of a plurality of normal-dose PET images that comprises a desired image quality; and providing the low-dose PET image to the neural network model to produce a denoised PET image, wherein the denoised PET image is iteratively reconstructed from the low-dose PET image during a reverse diffusion process in accordance with the score function.

In some embodiments, the operations further comprise generating, using a perception agent, a perception output based on the low-dose PET image, wherein the perception output comprises a misalignment, a noise level, or a lesion characterization; determining, using a scheduling agent and based on the perception output, one or more denoising parameters in association with the neural network model; generating, using the neural network model, a reconstructed image by performing a denoising operation on the low-dose PET image in accordance with the one or more denoising parameters; and providing, using a feedback agent, the reconstructed image as the denoised PET image based on the reconstructed image meeting or exceeding a quality criterion.

In some embodiments, the operations further comprise in response to the feedback agent determining that the denoised PET image does not satisfy the quality criterion, determining, using the scheduling agent, one or more alternative denoising parameters in association with another neural network model of the plurality of neural network models. In some embodiments, the feedback agent is configured to cause iterative refinement of the denoising operation such that the denoised PET image satisfies the quality criterion. In some embodiments, the plurality of neural network models is configured for a plurality of dose levels. In some embodiments, the operations further comprise training the 3D DDPM by incrementally adding noise to the plurality of normal-dose PET images during a forward diffusion process; and generating, based on the low-dose PET image, the denoised PET image from Gaussian noise during the reverse diffusion process. In some embodiments, the operations further comprise cropping the low-dose PET image; and dividing the low-dose PET image along an axial direction into a plurality of patches, wherein the plurality of patches overlaps sequentially by a plurality of pixels with a weighted arithmetic mean between adjacent patches of the plurality of patches.

According to some embodiments, one or more non-transitory computer-readable storage media store instructions that, when executed by one or more processors, cause the one or more processors to perform operations comprising receiving a low-dose positron emission tomography (PET) image; providing the low-dose PET image as a conditional input to a neural network model of a plurality of neural network models trained using a three-dimensional denoising diffusion probabilistic model (3D DDPM), wherein the neural network model comprises a score function that corresponds to a training of the neural network model based on three-dimensional distribution information of a plurality of normal-dose PET images that comprises a desired image quality; and providing the low-dose PET image to the neural network model to produce a denoised PET image, wherein the denoised PET image is iteratively reconstructed from the low-dose PET image during a reverse diffusion process in accordance with the score function.

In some embodiments, the operations further comprise generating, using a perception agent, a perception output based on the low-dose PET image, wherein the perception output comprises a misalignment, a noise level, or a lesion characterization; determining, using a scheduling agent and based on the perception output, one or more denoising parameters in association with the neural network model; generating, using the neural network model, a reconstructed image by performing a denoising operation on the low-dose PET image in accordance with the one or more denoising parameters; and providing, using a feedback agent, the reconstructed image as the denoised PET image based on the reconstructed image meeting or exceeding a quality criterion.

In some embodiments, the operations further comprise in response to the feedback agent determining that the denoised PET image does not satisfy the quality criterion, determining, using the scheduling agent, one or more alternative denoising parameters in association with another neural network model of the plurality of neural network models. In some embodiments, the feedback agent is configured to cause iterative refinement of the denoising operation such that the denoised PET image satisfies the quality criterion. In some embodiments, the plurality of neural network models is configured for a plurality of dose levels. In some embodiments, the operations further comprise training the 3D DDPM by incrementally adding noise to the plurality of normal-dose PET images during a forward diffusion process; and generating, based on the low-dose PET image, the denoised PET image from Gaussian noise during the reverse diffusion process.

### BRIEF DESCRIPTION OF THE DRAWINGS

Embodiments incorporating teachings of the present disclosure are shown and described with respect to the figures presented herein.

FIG. 1 is an example overview of an architecture in accordance with some embodiments of the present disclosure.

FIG. 2 is an example computing entity in accordance with some embodiments of the present disclosure.

FIG. 3 is an example client computing entity in accordance with some embodiments of the present disclosure.

FIG. 4 is a dataflow diagram of an example three-dimensional denoising diffusion probabilistic model (3D DDPM) framework in accordance with some embodiments of the present disclosure.

FIG. 5 is a dataflow diagram of an example multi-agent positron emission tomography (PET) image denoising system in accordance with some embodiments of the present disclosure.

FIG. 6 is a flowchart of an example process for denoising images according to some embodiments of the present disclosure.

FIG. 7 is a flowchart of an example process for selecting denoising models and parameters, according to some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

The present disclosure provides positron emission tomography (PET) image denoising for PET images (e.g., whole-body) based on a three-dimensional denoising diffusion probabilistic model (3D DDPM) that is able to accommodate variations in dose levels, scanners, and tracers.

Denoising may be performed on PET images to enhance quantitative accuracy and lesion-detection precision. A challenge in PET image denoising is posed by significant variations of noise levels, dynamic ranges, and intensity distributions. Such variations may result from differences in scanner types, scanning start times, dose levels, scan durations, tracer types, organs of interest, patient weights, etc. Given that PET image quality is significantly affected by the aforementioned factors, a need exists for PET image denoising that is able to adapt to diverse clinical settings.

Leveraging extensive computational resources and large-scale medical imaging datasets, deep learning methods may be applied to image denoising. However, existing deep learning-based denoising methods face challenges in adapting to the variability of clinical settings, influenced by factors, such as scanner types, tracer choices, dose levels, and acquisition times. For example, existing convolutional neural network (CNN)-based methods may produce overly smooth results, which may overlook lesions or pathological changes. Furthermore, CNNs may directly map inputs to outputs through convolution operations, which lack flexibility in adapting to different acquisition protocols. In another example, generative adversarial networks (GANs) may denoise images with less spatial blurring and improved visual quality by adding adversarial loss. However, GANs also face challenges, such as unstable adversarial training and mode collapse.

In yet another example, diffusion models may be used for various image processing tasks, such as denoising. A diffusion model may comprise a distribution learning-based model that gradually injects random noise into images during a forward diffusion phase and learn to reverse the forward diffusion process to reconstruct desired data samples from the noise. A stepwise refinement process allows a diffusion model to generate high-quality images consistently under varying conditions. However, existing diffusion model-based denoising models are limited to two-dimensional (2D) functionality, limiting their application in PET imaging as PET comprises a 3D imaging modality. Thus, existing diffusion model-based denoising models are unable to perceive 3D structural information from PET volumes.

A further challenge is that real-world scans span a wide spectrum of dose/count levels, patient sizes, and reconstruction settings. Consequently, a denoiser that performs well under one dose condition may fail under another, leading to either insufficient noise suppression or excessive smoothing that compromises lesion detectability. Therefore, dose-adaptive PET denoising with reliable validation is essential for robust clinical translation.

According to various embodiments of the present disclosure, an intelligent VLM- and LLM-driven multi-agent PET denoising framework is provided for low-dose PET image denoising driven by VLM/LLM reasoning. In some embodiments, the intelligent multi-agent framework of the present disclosure dynamically assesses image quality and lesion status, autonomously selects optimal denoising models and parameters, and enables closed-loop feedback with rollback mechanisms for robust and reliable operation. for. The intelligent multi-agent framework of the present disclosure may first perform multi-aspect perception: an anatomy-aware agent analyzes PET/CT consistency and identifies potential PET-CT mismatches; a dose-aware agent estimates the dose/count level from the input PET using a fine-tuned BiomedCLIP VLM; and a lesion-aware agent segments lesions and summarizes lesion status for downstream decision-making. Based on the structured perception report and a curated knowledge base derived from empirical denoising experience, an LLM-based scheduler may select an appropriate dose-specific conditional diffusion denoiser and corresponding inference parameter settings, including the strength of a data consistency constraint. After denoising, a feedback agent may re-evaluate organ-level noise reduction and checks quantitative stability, with explicit safeguards for lesion preservation. If the output does not meet predefined criteria, the intelligent multi-agent framework of the present disclosure may roll back and reschedule with updated context. Together, the components of the intelligent multi-agent framework of the present disclosure may provide a unified and automated solution for robust PET denoising across diverse dose levels.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable storage media (including volatile and non-volatile media).

A non-volatile computer-readable storage medium may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random-access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Architecture

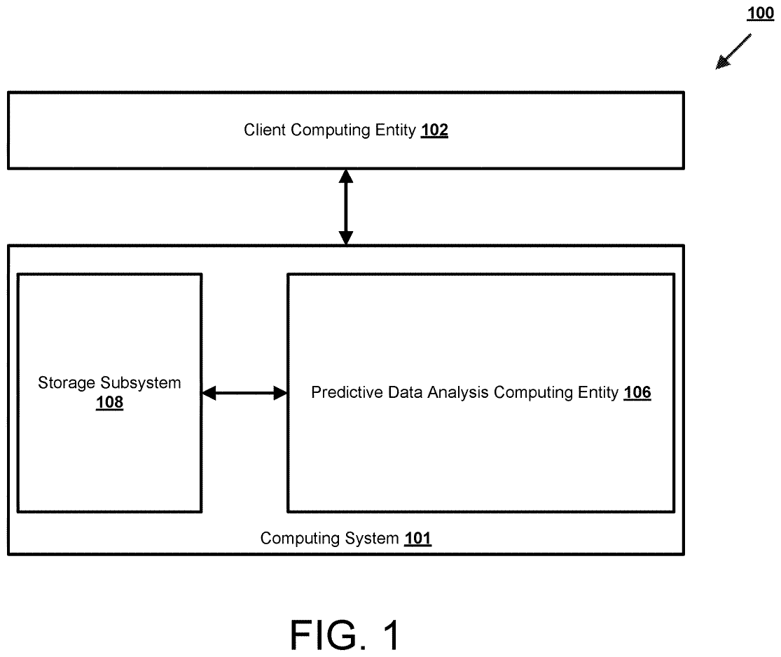

FIG. 1 is an example overview of an architecture 100 in accordance with some embodiments of the present disclosure. The architecture 100 includes a computing system 101 configured to receive image processing (e.g., PET image denoising) requests from client computing entity 102, process the image processing requests to generate processed images (e.g., denoised PET images), and provide the processed images to the client computing entity 102.

In some embodiments, computing system 101 may communicate with at least one of the client computing entity 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include an image processing computing entity 106 and a storage subsystem 108. The image processing computing entity 106 may be configured to receive image processing (e.g., PET image denoising) requests from client computing entity 102, process the image processing requests to generate processed images (e.g., denoised PET images), and provide the processed images to the client computing entity 102.

The storage subsystem 108 may be configured to store input data used by the image processing computing entity 106 to perform image processing (e.g., PET image denoising). The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Example Data Analysis Computing Entity

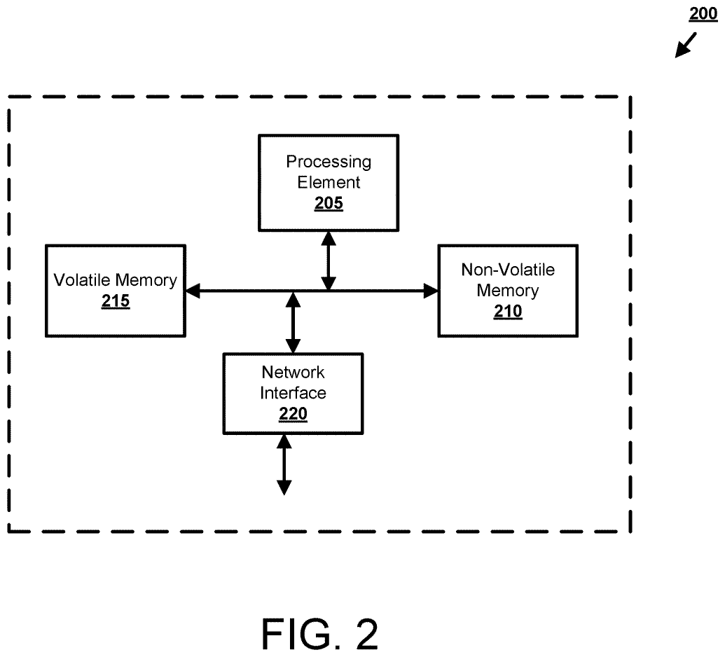

FIG. 2 is an example computing entity 200 in accordance with some embodiments of the present disclosure. The computing entity 200 is an example of the image processing computing entity 106. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like.

As shown in FIG. 2, in one embodiment, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Thus, the processing elements 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In one embodiment, the computing entity 200 may further include, or be in communication with, non-volatile media (also referred to as non-volatile storage, memory, memory storage, memory circuitry, and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the computing entity 200 may further include, or be in communication with, volatile media (also referred to as volatile storage, memory, memory storage, memory circuitry, and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing elements 205. Thus, the databases, database instances, database management systems, data, applications, programs, program modules, scripts, source code, object code, byte code, compiled code, interpreted code, machine code, executable instructions, and/or the like may be used to control certain aspects of the operation of the computing entity 200 with the assistance of the processing elements 205 and operating system.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 200 may be configured to communicate via wireless external communication networks using any of a variety of protocols, such as new radio (NR), general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### Example Client Computing Entity

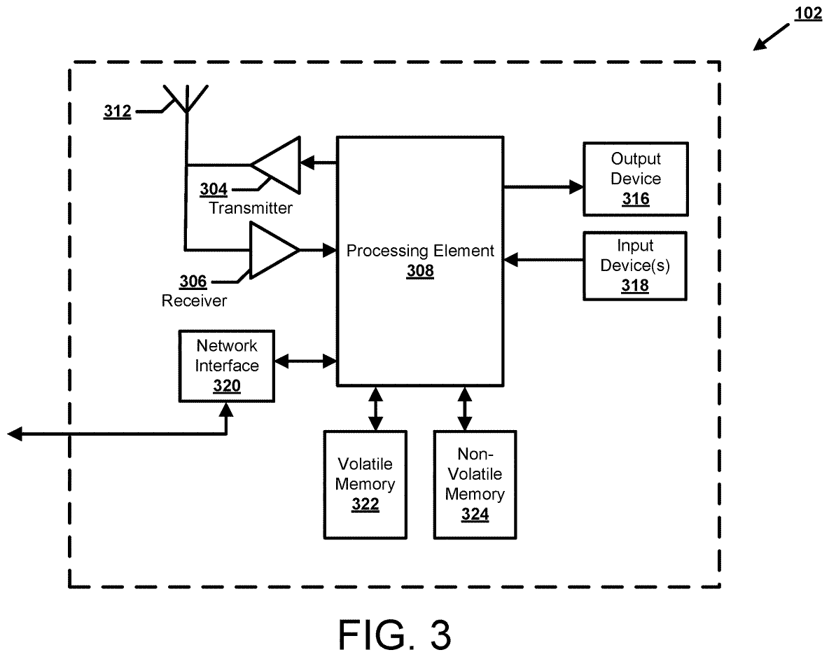

FIG. 3 is an example client computing entity 102 in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entity 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In a particular embodiment, the client computing entity 102 may operate in accordance with multiple wireless communication standards and protocols, such as NR, GPRS, UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile storage or memory 322 and/or non-volatile storage or memory 324, which may be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMIM, DIMM, SIMM, VRAM, cache memory, register memory, and/or the like. The volatile and non-volatile storage or memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionality that are the same or similar to those of the computing entity 200, as described in greater detail above. As will be recognized, these architectures and descriptions are provided for exemplary purposes only and are not limited to the various embodiments.

In various embodiments, the client computing entity 102 may be embodied as an artificial intelligence (AI) computing entity. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example Three-Dimensional Denoising Diffusion Probabilistic Model (3D DDPM) Framework

Various embodiments of the present disclosure describe steps, operations, processes, methods, functions, and/or the like for enhancing the quality of low-dose whole-body PET images. In some embodiments, a 3D DDPM framework is configured to perform 3D PET image denoising. The 3D DDPM framework may utilize a diffusion process to learn (e.g., train a neural network) an underlying 3D PET data distribution from PET images and employ knowledge (e.g., using the trained neural network) gained from learning the underlying 3D PET data distribution to denoise low-quality PET images.

In some embodiments, a 3D DDPM framework comprises training a neural network by gradually injecting noise into training data during a forward diffusion process to perturb the training data. The training data may comprise pairs of PET images that correspond to various radiation dosing quantities. For example, a PET image pair may comprise a normal-dose PET image and a low-dose PET image. A normal-dose PET image may comprise an image that is associated with a normal dose of radiation used to capture the image. On the other hand, a low-dose PET image may comprise an image that is associated with a dose of radiation that is lower than a normal dose used to capture the image. In some embodiments, a normal dose comprises an effective radiation dosage (e.g., approximately 30 mSv) that may be applied to capture a PET image with a sufficient high amount of resolution. In some embodiments, a low dose may refer to a radiation dosage that is lower than, or a portion of, a normal dose. As such, a normal-dose PET image may comprise a desirable amount of image quality (e.g., resolution) and a low-dose PET image may comprise a less than desirable amount of image quality. That is, the quality of a PET image may be directly proportional to dosing. In some embodiments, after training the neural network, input data comprising a low-dose PET image is provided to the 3D DDPM framework for conversion into denoised output data during a reverse diffusion process. For example, the denoised output data may comprise an enhanced (e.g., higher-resolution or denoised) PET image that is recovered from the input data.

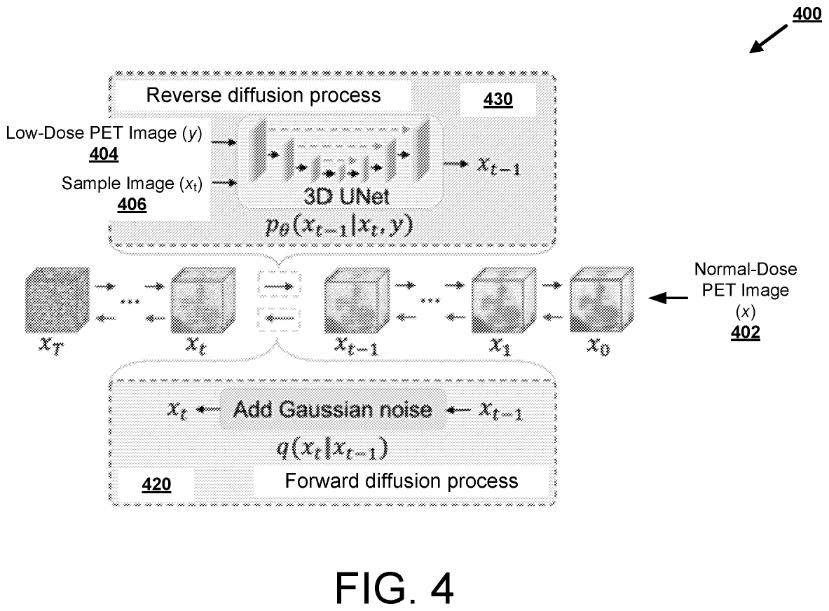

FIG. 4 is a dataflow diagram of an example 3D DDPM framework 400 in accordance with some embodiments of the present disclosure. A forward diffusion process 420 of the 3D DDPM framework 400 comprises sampling a normal-dose PET image (x) 402 (e.g., from a data distribution q(x)). During the forward diffusion process 420, Gaussian noise is iteratively added to images x₀-xₜ over T time steps, following a predefined variance schedule

$${\{ {β}_{t} \}}_{t = 1}^{T}$$

where βₜ∈(0,1) is increased gradually. The forward diffusion process 420 may be formulated as a Markov chain as,

$$q ( {x}_{1 : T} \vert {x}_{0} ) = {\prod }_{t = 1}^{T} q ( {x}_{t} \vert {x}_{t - 1} ) , \\ q ( {x}_{t} \vert {x}_{t - 1} ) = 𝒩 ( {x}_{t} ; \sqrt{1 - {β}_{t}} {x}_{t - 1} , {β}_{t} I ) \qquad Equation 1$$

By introducing αₜ=1−βₜ and

$${\overline{α}}_{t} = {\prod }_{s = 1}^{t} {α}_{s} ,$$

may be sampled at any time step directly from x₀, and as such, the forward diffusion process 420 may be further expressed by:

$$q ( {x}_{t} \vert {x}_{0} ) = 𝒩 ( {x}_{t} ; \sqrt{{\overline{α}}_{t}} {x}_{0} , ( 1 - {\overline{α}}_{t} ) I ) \qquad Equation 2$$

The reverse diffusion process 430 may comprise sampling a conditional probability q(xₜ₋₁|xₜ) to reverse the forward diffusion process 420 and to recover a noise-free image x₀ from [symbol] Gaussian noise x_{T}~ [symbol] . When the variance (βₜ) of the added noise c is sufficiently small, a conditional distribution from the sampling may be approximated as a Gaussian distribution when conditioned on x₀:

$$q ( {x}_{t - 1} \vert {x}_{t} , {x}_{0} ) = 𝒩 ( {x}_{t - 1} ; {\tilde{u}}_{t} \vert ( {x}_{t} , {x}_{0} ) , {\tilde{β}}_{t} I ) , \qquad Equation 3$$

$$where ,$$

$${\tilde{u}}_{t} ( {x}_{t} , {x}_{0} ) = \frac{\sqrt{{\overline{a}}_{t - 1}} {β}_{t}}{1 - {\overline{a}}_{t}} {x}_{0} + \frac{\sqrt{{\overline{a}}_{t}} ( 1 - {\overline{a}}_{t - 1} )}{1 - {\overline{a}}_{t}} {x}_{t} and {\tilde{β}}_{t} = \frac{1 - {\overline{α}}_{t - 1}}{1 - {\overline{α}}_{t}} {β}_{t} \qquad Equation 4$$

To facilitate PET image denoising, a low-dose PET image γ 404 may be provided as an input into a neural network model po trained with trainable parameters θ to guide the image generation, rather than random generation of new samples. During inference, image x₀ may be predicted (e.g., the desired output) during the reverse diffusion process 430, and as such, the neural network model p_{θ} may approximate the above conditional properties without direct dependence on x₀ as

$${p}_{θ} ( {x}_{t - 1} \vert {x}_{t} , y ) = 𝒩 ( {x}_{t - 1} ; {μ}_{θ} ( {x}_{t} , y , t ) , {σ}_{t}^{2} I , \qquad Equation 5$$

where the low-dose PET image γ 404 is provided as a conditional input to guide the reverse diffusion process 430. The variance

$${σ}_{t}^{2}$$

may be set to constants derived from the variance schedule. Rather than directly estimating and/or determining the mean μ_{θ}, predicted noise ∈_{θ} (hereinafter referred to a score function) may be estimated thereby simplifying the learning process. Accordingly, an update equation for estimating xₜ₋₁ at each time step using the score function ∈_{θ} may be determined by:

$${x}_{t - 1} = \frac{1}{\sqrt{{α}_{t}}} ( {x}_{t} - \frac{{β}_{t}}{\sqrt{1 - {\overline{α}}_{t}}} {ϵ}_{θ} ( {x}_{t} , y , t ) ) + {σ}_{t} z , where z ∼ 𝒩 ( 0 , I ) . \qquad Equation 6$$

The input to neural network model p_{θ} may be an image pair comprising a sample image xₜ 406 at time t (e.g., a stochastic intermediate state of the sample at timestep t in the reverse diffusion process 430, lying between the pure noise sample x_{T} and the reconstructed data sample x₀) and the low-dose PET image γ 404, with the score function ∈_{θ}(xₜ, y, t).

For score-function optimization, the neural network model p_{θ} may minimize the difference between true noise ∈ added during the forward diffusion process 420 and the score function ∈_{θ} by using the following objective function:

$$L ( θ ) = {𝔼}_{t , {x}_{0} , ϵ} [ {‖ ϵ - {ϵ}_{θ} ( {x}_{t} , y , t ) ‖}^{2} ] . \qquad Equation 7$$

In some embodiments, the score function ∈_{θ} is trained on datasets that are acquired from one or more PET/computed tomography (CT) scanning devices. In some embodiments, a dataset comprises PET images that are associated with a total body view. In some embodiments, a dataset comprises PET images that are associated with a view of a specific body part and/or location. In some embodiments, a PET image comprises a 3D image matrix comprising dimensions in the coronal, sagittal, and axial planes. In some embodiments, a dataset comprises PET images with varying characteristics, including, but not limited to, signal-to-noise ratio, resolution, and/or voxel size. In some embodiments, a dataset comprises PET images that are associated with one or more radioactive tracers.

In some embodiments, a dataset comprises PET images that respectively correspond to (e.g., captured using) different dose levels. The different dose levels may comprise a normal dose and one or more low doses (e.g., ½, ¼, 1/10, 1/20, 1/50, and/or 1/100 of the normal dose). In some embodiments, a dataset comprises a plurality of PET image pairs, wherein a PET image pair comprises a normal-dose PET image and a low-dose PET image. The normal-dose PET image may be used as the ground truth (e.g., during training, validation, and/or testing) for comparison in reconstructing the normal-dose PET from the low-dose PET image during the reverse diffusion process. In some embodiments, pre-processing is performed on PET images in a dataset. In some embodiments, pre-processing comprises cropping and/or removal of non-essential parts, such as the empty background. In some embodiments, pre-processing of the PET images comprises conversion into standardized uptake value (SUV) units. In some embodiments, due to GPU memory constraints, PET images of a training dataset are randomly cropped into 96×96×96 patches before being provided the 3D DDPM during training. During sampling (e.g., reverse diffusion), low-dose PET images (γ) may be divided along the axial direction into six patches with dimensions 192×288×96. The patches may overlap, for example, sequentially by 10 pixels, with a weighted arithmetic mean applied to ensure smooth transitions between adjacent patches. In some embodiments, PET images of a dataset are divided into a training dataset, a validation dataset, and a test dataset.

In some embodiments, a plurality of neural network models may be trained, wherein each neural network model of the plurality of neural network models is configured for a specific dose level. For example, a first neural network model may be trained using PET image pairs corresponding to a ½ dose level, a second neural network model may be trained using PET image pairs corresponding to a ¼ dose level, a third neural network model may be trained using PET image pairs corresponding to a 1/10 dose level, and so forth. A neural network model of a plurality of neural network models may learn specific noise characteristics and distribution patterns associated with a corresponding dose level, thereby enabling more accurate denoising for a particular dose level. In some embodiments, during inference, an appropriate neural network model is selected from a plurality of neural network models based on an estimated dose level of an input low-dose PET image. By training dose-specific neural network models, a denoising system may provide improved performance across a range of dose levels.

### Example Multi-Agent PET Image Denoising System

Various embodiments of the present disclosure provide a vision language model (VLM)- and/or large language model (LLM)-based intelligent multi-agent PET image denoising system that autonomously selects optimal denoising models and/or parameters based on dynamically perceived low-dose image quality and lesion status, and facilities closed-loop feedback with rollback.

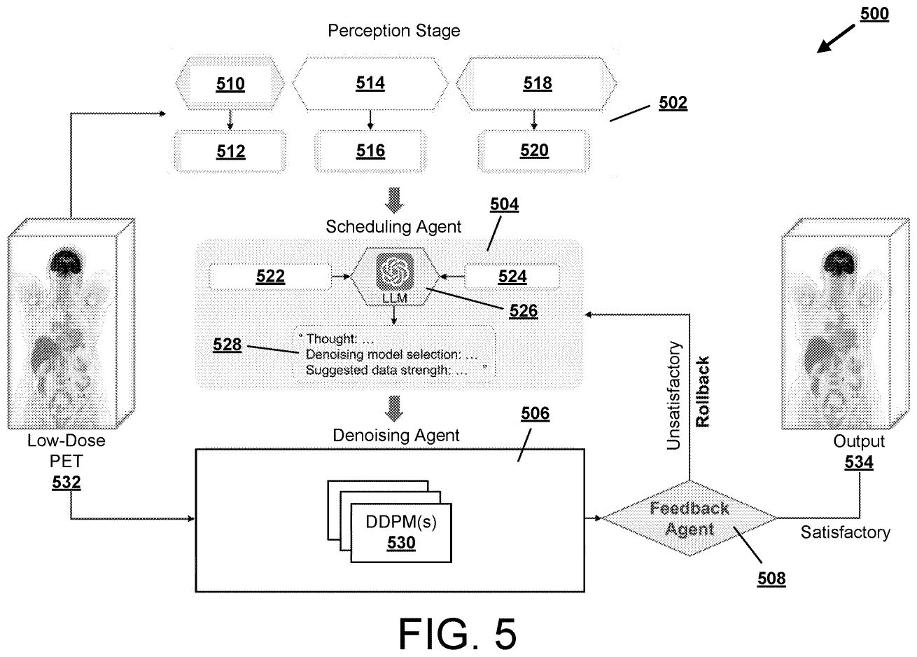

FIG. 5 is a dataflow diagram of an example multi-agent PET image denoising system 500 in accordance with some embodiments of the present disclosure.

The multi-agent PET image denoising system 500 comprises a perception stage 502, a scheduling agent 504, a denoising agent 506, and a feedback agent 508. The perception stage 502 may be configured to perform low-dose PET quality and lesion perception functions. The perception stage 502 comprises an anatomy-aware agent 510, a dose-aware agent 514, and a lesion-aware agent 518.

The anatomy-aware agent 510 may be configured to check for potential misalignment between the low-dose PET image 532 and CT images of the same patient for misalignment 512. Misalignment may occur due to respiratory motion and/or patient motion. Such misregistration may affect lesion localization and quality assessment. The anatomy-aware agent 510 may generate organ masks from both modalities and compare organ locations and overlaps, with emphasis on motion-sensitive organs, such as the lung and liver. When organ disagreement indicates potential misalignment, the anatomy-aware agent 510 may issue a warning suggesting additional registration. Additionally, and/or alternatively, organ-specific quality assessment may be enabled by the segmentation masks, allowing the anatomy-aware agent 510 to compute organ-level noise statistics that guide denoiser selection and serve as reference measurements for post-denoising evaluation.

The dose-aware agent 514 may be configured to estimate the noise level 516 of the low-dose PET image 532. In some embodiments, the dose-aware agent 514 comprises a fine-tuned large-scale biomedical VLM, such as BiomedCLIP, to estimate PET dose level of the low-dose PET image 532. A dose level may be represented by a text prompt, and the fine-tuned large-scale biomedical VLM may predict the level whose prompt embedding is most similar to an image embedding in a shared representation space. To preserve general biomedical semantics, original text and image encoders of the fine-tuned large-scale biomedical VLM may be frozen and introduce a lightweight image-side controller initialized from a pretrained image encoder. The controller may be optimized using contrastive learning so that embeddings of low-dose PET images may align with their corresponding dose prompts. For a 3D PET scan, predictions may be first produced at the axial-slice level and then aggregated to yield a subject-level estimate and confidence score. Accordingly, the dose-aware agent 514 may provide robust automated dose awareness that is subsequently used for dose-specific model selection.

The lesion-aware agent 518 may be configured to characterize lesion presence and location. The lesion-aware agent 518 may perform whole-body lesion segmentation and summarize lesion status for scheduling and feedback validation. In some embodiments, a 3D nnU-Net is trained for PET lesion segmentation, with a ResNet encoder and a larger patch size (192×192×192) to increase the receptive field and improve robustness for whole body coverage. The lesion-aware agent 518 may generate a lesion presence and location output 520 that comprises a lesion mask and one or more lesion descriptors, e.g., including lesion SUVₘₐₓ.

Perception outputs (e.g., comprising 512, 516, and 520) from the scheduling agent 504, the denoising agent 506, and the feedback agent 508 may be converted into a compact, structured report for the scheduling agent 504. For example, a report may be generated that comprises potential PET/CT alignment warnings, organ-level noise statistics, estimated dose level with confidence, and/or lesion summaries. The scheduling agent 504 may be configured to integrate the perception outputs with domain knowledge 524 to generate a denoiser and inference setting output 528. To provide PET denoising domain knowledge or to reliably select among specialized models the domain knowledge 524 may be derived from empirical exploration, such as common failure modes (e.g., over-smoothing and lesion disappearing), recommended model choices for different dose levels, and safe ranges for key inference settings. Based on the perception outputs and the domain knowledge 524 the scheduling agent 504 generates the denoiser and inference setting output 528 comprising a denoising plan specifying a dose-specific conditional diffusion model and a recommended data-consistency strength.

The denoising agent 506 may comprise access to a plurality of dose-specific conditional DDPMs 530 to perform denoising execution by selecting a dose-specific conditional DDPM from the plurality of dose-specific conditional DDPMs 530 based on the denoiser and inference setting output 528.

The feedback agent 508 may be configured to perform feedback evaluation of reconstructed images generated by the denoising agent 506 using the dose-specific conditional DDPM. Reconstructed images may be evaluated by re-assessing noise and lesion quantification. For example, organ-level noise reduction and quantitative stability may be evaluated by comparing organ bias and lesion SUV metrics before and after denoising. A determination of reconstructed images that are unsatisfactory may trigger rollback and/or rescheduling by the scheduling agent 504. Otherwise, reconstructed images that are satisfactory may be provided as denoised output 534. Accordingly, the multi-agent PET image denoising system 500 may provide robust low-dose PET image denoising across various dose levels while preserving lesion details. By performing image quality/lesion perception, denoising scheduling, and closed-loop validation with rollback, the multi-agent PET image denoising system 500 may streamline a denoising workflow.

In some embodiments, the feedback agent 508 evaluates reconstructed images against one or more quality criteria. The quality criteria may comprise, but are not limited to, signal-to-noise ratio thresholds, lesion preservation metrics, quantitative accuracy measures, structural similarity indices, and/or visual quality assessments. For example, the feedback agent 508 may determine whether a reconstructed image meets or exceeds a signal-to-noise ratio threshold, whether lesion boundaries and uptake values are preserved within acceptable tolerances, and/or whether quantitative accuracy metrics (e.g., standardized uptake value accuracy) satisfy predefined criteria. In some embodiments, the feedback agent 508 performs iterative refinement of a denoising operation. During iterative refinement, if a reconstructed image does not satisfy the quality criterion, the feedback agent 508 may trigger the scheduling agent 504 to determine one or more alternative denoising parameters and/or to select another neural network model from the plurality of dose-specific conditional DDPMs 530. The denoising agent 506 may then perform another denoising operation using the alternative parameters and/or model, and the feedback agent 508 may re-evaluate the resulting reconstructed image. This iterative process may continue until the reconstructed image satisfies the quality criterion or until a maximum number of iterations is reached. In some embodiments, rollback may be performed when the quality criterion is not met. Rollback may comprise reverting to a previous state, discarding an unsatisfactory reconstructed image, and/or re-initiating the denoising process with different parameters. The rollback mechanism may enable the multi-agent PET image denoising system 500 to recover from suboptimal denoising results and to explore alternative denoising configurations.

### Example System Operations

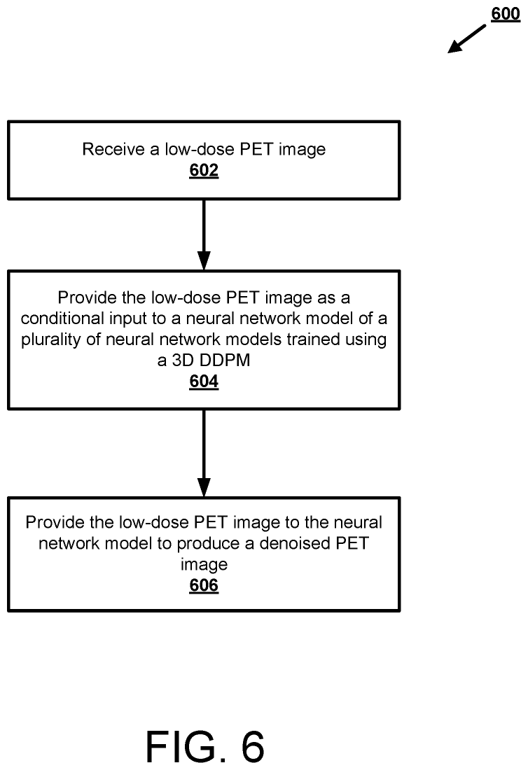

FIG. 6 is a flowchart of an example process 600 for denoising images according to some embodiments of the present disclosure.

In some embodiments, the process 600 begins at step/operation 602 when the computing system 101 receives a low-dose PET image.

In some embodiments, at step/operation 604, the computing system 101 provides the low-dose PET image as a conditional input to a neural network model of a plurality of neural network models trained using a 3D DDPM, wherein the neural network model comprises a score function that corresponds to a training of the neural network model based on three-dimensional distribution information of a plurality of normal-dose PET images that comprises a desired image quality.

In some embodiments, at step/operation 606, the computing system 101 provides the low-dose PET image to the neural network model to produce a denoised PET image, wherein the denoised PET image is iteratively reconstructed from the low-dose PET image during a reverse diffusion process in accordance with the score function.

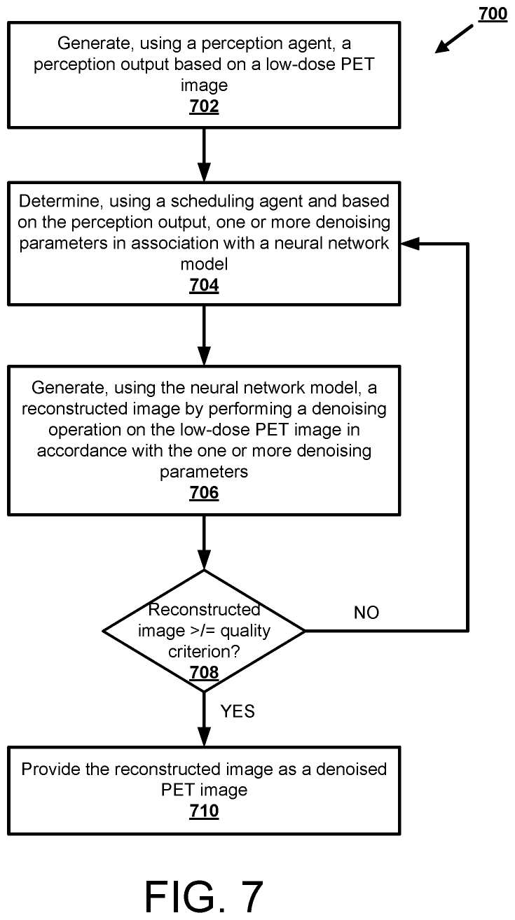

FIG. 7 is a flowchart of an example process 700 for selecting denoising models and parameters, according to some embodiments of the present disclosure.

In some embodiments, the process 700 begins at step/operation 702 when the computing system 101 generates, using a perception agent, a perception output based on a low-dose PET image, wherein the perception output comprises a misalignment, a noise level, or a lesion characterization.

In some embodiments, at step/operation 704, the computing system 101 determines, using a scheduling agent and based on the perception output, one or more denoising parameters in association with a neural network model.

In some embodiments, at step/operation 706, the computing system 101 generates, using the neural network model, a reconstructed image by performing a denoising operation on the low-dose PET image in accordance with the one or more denoising parameters.

In some embodiments, at step/operation 708, the computing system 101 determines, using a feedback agent, whether the reconstructed image meets or exceeds a quality criterion. If the reconstructed image does not meet or exceed the quality criterion, the process 700 returns to step/operation 704.

In some embodiments, at step/operation 710, the computing system 101 provides, using the feedback agent, the reconstructed image as a denoised PET image based on the reconstructed image meeting or exceeding a quality criterion.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

What is claimed is:

1. A computer-implemented method comprising:
receiving, by one or more processors, a low-dose positron emission tomography (PET) image;
providing, by the one or more processors, the low-dose PET image as a conditional input to a neural network model of a plurality of neural network models trained using a three-dimensional denoising diffusion probabilistic model (3D DDPM), wherein the neural network model comprises a score function that corresponds to a training of the neural network model based on three-dimensional distribution information of a plurality of normal-dose PET images that comprises a desired image quality; and
providing, by the one or more processors, the low-dose PET image to the neural network model to produce a denoised PET image, wherein the denoised PET image is iteratively reconstructed from the low-dose PET image during a reverse diffusion process in accordance with the score function.

2. The computer-implemented method of claim 1 further comprising:
generating, using a perception agent, a perception output based on the low-dose PET image, wherein the perception output comprises a misalignment, a noise level, or a lesion characterization;
determining, using a scheduling agent and based on the perception output, one or more denoising parameters in association with the neural network model;
generating, using the neural network model, a reconstructed image by performing a denoising operation on the low-dose PET image in accordance with the one or more denoising parameters; and
providing, using a feedback agent, the reconstructed image as the denoised PET image based on the reconstructed image meeting or exceeding a quality criterion.

3. The computer-implemented method of claim 2, further comprising:
in response to the feedback agent determining that the denoised PET image does not satisfy the quality criterion, determining, using the scheduling agent, one or more alternative denoising parameters in association with another neural network model of the plurality of neural network models.

4. The computer-implemented method of claim 2, wherein the feedback agent is configured to cause iterative refinement of the denoising operation such that the denoised PET image satisfies the quality criterion.

5. The computer-implemented method of claim 1, wherein the plurality of neural network models is configured for a plurality of dose levels.

6. The computer-implemented method of claim 1 further comprising training the 3D DDPM by:
incrementally adding noise to the plurality of normal-dose PET images during a forward diffusion process; and
generating, based on the low-dose PET image, the denoised PET image from Gaussian noise during the reverse diffusion process.

7. The computer-implemented method of claim 1 further comprising:
cropping the low-dose PET image; and
dividing the low-dose PET image along an axial direction into a plurality of patches, wherein the plurality of patches overlaps sequentially by a plurality of pixels with a weighted arithmetic mean between adjacent patches of the plurality of patches.

8. A system comprising
one or more processors and
one or more non-transitory computer readable media storing processor-executable instructions that, when executed by the one or more processors, cause the one or more processors to perform operations comprising:
receiving a low-dose positron emission tomography (PET) image;
providing the low-dose PET image as a conditional input to a neural network model of a plurality of neural network models trained using a three-dimensional denoising diffusion probabilistic model (3D DDPM), wherein the neural network model comprises a score function that corresponds to a training of the neural network model based on three-dimensional distribution information of a plurality of normal-dose PET images that comprises a desired image quality; and
providing the low-dose PET image to the neural network model to produce a denoised PET image, wherein the denoised PET image is iteratively reconstructed from the low-dose PET image during a reverse diffusion process in accordance with the score function.

9. The system of claim 8, wherein the operations further comprise:
generating, using a perception agent, a perception output based on the low-dose PET image, wherein the perception output comprises a misalignment, a noise level, or a lesion characterization;
determining, using a scheduling agent and based on the perception output, one or more denoising parameters in association with the neural network model;
generating, using the neural network model, a reconstructed image by performing a denoising operation on the low-dose PET image in accordance with the one or more denoising parameters; and
providing, using a feedback agent, the reconstructed image as the denoised PET image based on the reconstructed image meeting or exceeding a quality criterion.

10. The system of claim 9, wherein the operations further comprise:
in response to the feedback agent determining that the denoised PET image does not satisfy the quality criterion, determining, using the scheduling agent, one or more alternative denoising parameters in association with another neural network model of the plurality of neural network models.

11. The system of claim 9, wherein the feedback agent is configured to cause iterative refinement of the denoising operation such that the denoised PET image satisfies the quality criterion.

12. The system of claim 8, wherein the plurality of neural network models is configured for a plurality of dose levels.

13. The system of claim 8, wherein the operations further comprise training the 3D DDPM by:
incrementally adding noise to the plurality of normal-dose PET images during a forward diffusion process; and
generating, based on the low-dose PET image, the denoised PET image from Gaussian noise during the reverse diffusion process.

14. The system of claim 8, wherein the operations further comprise:
cropping the low-dose PET image; and
dividing the low-dose PET image along an axial direction into a plurality of patches, wherein the plurality of patches overlaps sequentially by a plurality of pixels with a weighted arithmetic mean between adjacent patches of the plurality of patches.

15. One or more non-transitory computer-readable storage media storing instructions that, when executed by one or more processors, cause the one or more processors to perform operations comprising:
receiving a low-dose positron emission tomography (PET) image;
providing the low-dose PET image as a conditional input to a neural network model of a plurality of neural network models trained using a three-dimensional denoising diffusion probabilistic model (3D DDPM), wherein the neural network model comprises a score function that corresponds to a training of the neural network model based on three-dimensional distribution information of a plurality of normal-dose PET images that comprises a desired image quality; and
providing the low-dose PET image to the neural network model to produce a denoised PET image, wherein the denoised PET image is iteratively reconstructed from the low-dose PET image during a reverse diffusion process in accordance with the score function.

16. The one or more non-transitory computer-readable storage media of claim 15, wherein the operations further comprise:
generating, using a perception agent, a perception output based on the low-dose PET image, wherein the perception output comprises a misalignment, a noise level, or a lesion characterization;
determining, using a scheduling agent and based on the perception output, one or more denoising parameters in association with the neural network model;
generating, using the neural network model, a reconstructed image by performing a denoising operation on the low-dose PET image in accordance with the one or more denoising parameters; and
providing, using a feedback agent, the reconstructed image as the denoised PET image based on the reconstructed image meeting or exceeding a quality criterion.

17. The one or more non-transitory computer-readable storage media of claim 16, wherein the operations further comprise:
in response to the feedback agent determining that the denoised PET image does not satisfy the quality criterion, determining, using the scheduling agent, one or more alternative denoising parameters in association with another neural network model of the plurality of neural network models.

18. The one or more non-transitory computer-readable storage media of claim 16, wherein the feedback agent is configured to cause iterative refinement of the denoising operation such that the denoised PET image satisfies the quality criterion.

19. The one or more non-transitory computer-readable storage media of claim 15, wherein the plurality of neural network models is configured for a plurality of dose levels.

20. The one or more non-transitory computer-readable storage media of claim 15, wherein the operations further comprise training the 3D DDPM by:
incrementally adding noise to the plurality of normal-dose PET images during a forward diffusion process; and
generating, based on the low-dose PET image, the denoised PET image from Gaussian noise during the reverse diffusion process.
